(19) United States
(12) Patent Application Publication
(10) Pub. No.: US 2018/0287670 A1
(43) Pub. Date: Oct. 4, 2018

(54) JOINT DATA TRANSMISSION METHOD AND DEVICE

(71) Applicant: Huawei Technologies Co., Ltd., Shenzhen (CN)

(72) Inventors: Jingbo PENG, Shanghai (CN); Qiuping ZHU, Shanghai (CN)

(21) Appl. No.: 16/000,304

(22) Filed: Jun. 5, 2018

Related U.S. Application Data
(63) Continuation of application No. PCT/CN2016/109058, filed on Dec. 8, 2016.

(30) Foreign Application Priority Data
Dec. 31, 2015 (CN) 201511032504.2

(51) Int. Cl. H04B 7/024; H04B 7/06

(52) U.S. Cl. CPC H04B 7/024; H04B 7/0695

(57) ABSTRACT

A joint data transmission method and a device are disclosed. Distributed transmit units are divided into subclusters, target user equipment is selected from each subcluster, and further, grouping is performed on a user equipment basis to reduce a quantity of dimensions, so that a joint transmission parameter is determined, and joint data transmission is performed. This way, interference between subclusters can be avoided and complexity is reduced, thereby improving system performance.

### CROSS-REFERENCE TO RELATED APPLICATIONS

This application is a continuation of International Application No. PCT/CN2016/109058, filed on Dec. 8, 2016, which claims priority to Chinese Patent Application No. 201511032504.2, filed on Dec. 31, 2015, the disclosures of which are incorporated herein by reference in their entireties.

### TECHNICAL FIELD

This application relates to the communications field, and in particular, to a joint data transmission method and a device.

### BACKGROUND

A distributed antenna system simultaneously transmits data to a plurality of user equipment by using distributed transmit units distributed at different geographic locations, such as a location of a radio remote unit (RRU). As shown in FIG. 1, a distributed transmit unit (represented by a triangle) 1A transmits data to user equipment (represented by a dot) 1B, and a distributed transmit unit 2A transmits data to user equipment 2B. When the distributed transmit unit transmits, based on this communication mechanism, data to user equipment served by the distributed transmit unit, interference is caused to another user equipment. For example, in FIG. 1, the distributed transmit unit 1A causes interference to the user equipment 2B, and the distributed transmit unit 2A causes interference to the user equipment 1B. The foregoing phenomenon refers to as mutual interference within the distributed antenna system.

Currently, a joint data transmission technology is used to resolve a problem of mutual interference between channels in the distributed antenna system. Joint data transmission is explained herein: A transmit weight or power used by each transmit antenna to transmit a signal is calculated according to information such as a statistical channel characteristic or a real-time channel characteristic between each distributed transmit unit and each user equipment, and to-be-transmitted data of each user equipment is transmitted after being weighted by using the weight, so that a signal carrying data of another user equipment is reversely offset when arriving at this user equipment, to cancel interference.

However, existing joint data transmission technologies have relatively high complexity.

### SUMMARY

This disclosure provides a joint data transmission method and a device to reduce joint data transmission complexity while ensuring distributed antenna system performance.

To achieve the foregoing objective, embodiments of the disclosure provide the following technical solutions.

According to one aspect, a joint data transmission method includes: dividing, by a processing unit (or processor), distributed transmit units connected to the processing unit into N subclusters; selecting, by the processing unit, one or more target user equipment from user equipment covered by each subcluster; and performing, by the processing unit, joint data transmission for the one or more target user equipment by using the distributed transmit units in the N subclusters.

According to another aspect, a joint data transmission method includes: dividing, by a processing unit, distributed transmit units connected to the processing unit into N subclusters; selecting, by the processing unit, one or more target user equipment from user equipment covered by each subcluster; for any one of the one or more target user equipment, selecting, by the processing unit, one or more distributed transmit units for the target user equipment from the distributed transmit units in the N subclusters, determining another target user equipment that receives interference from the selected distributed transmit unit, and determining a transmit parameter of the target user equipment according to information about the interference caused by the selected distributed transmit unit to the other target user equipment; and performing, by the processing unit, joint data transmission by using a determined transmit parameter of the one or more target user equipment.

According to yet another aspect, a joint data transmission method includes: dividing, by a processing unit, distributed transmit units connected to the processing unit into N subclusters; selecting, by the processing unit, one or more target user equipment from user equipment covered by each subcluster; for any one of the one or more target user equipment, selecting, by the processing unit, one or more distributed transmit units for the target user equipment from the distributed transmit units in the N subclusters, selecting one or more beams for the user equipment from beams transmitted by the selected distributed transmit unit, determining another target user equipment that receives interference from the selected beam, and determining a transmit parameter of the user equipment according to information about the interference caused by the selected beam to the other target user equipment; and performing joint data transmission by using a determined transmit parameter of the one or more target user equipment, where the beam is produced by a plurality of distributed transmit units in the N subclusters, and different beams to different user equipment have different radiation intensities.

According to still another aspect, a joint data transmission method includes: dividing, by a processing unit, distributed transmit units connected to the processing unit into N subclusters; selecting, by the processing unit, one or more target user equipment from user equipment covered by each subcluster; for any one of the one or more target user equipment, selecting, by the processing unit, a corresponding distributed transmit unit for the target user equipment from the distributed transmit units in the N subclusters; for each distributed transmit unit, determining, by the processing unit, another target user equipment that receives interference from the transmit unit, and calculating, according to information about the interference to the other target user equipment, a transmission parameter of user equipment corresponding to the distributed transmit unit; and transmitting, by the processing unit, signals together that are transmitted by a plurality of different distributed transmit units to same user equipment.

According to the foregoing joint data transmission methods, interference between subclusters can be avoided, thereby improving system performance. In addition, compared with the prior art, the foregoing joint data transmission methods have relatively low complexity.

According to another aspect, a baseband processing unit includes a processor and a memory, where the memory is configured to store an application program and data generated in a process of running the application program by the processor; and the processor is configured to run the application program stored in the memory, to implement the foregoing joint data transmission process.

According to yet another aspect, a base station includes the foregoing baseband processor.

According to still another aspect, a distributed transmit system includes a plurality of RRUs and a baseband processing unit (BBU), or baseband processor, connected to the plurality of RRUs, where the BBU is the foregoing baseband processor.

According to another aspect, a distributed transmit system includes a plurality of first base stations and a second base station connected to the plurality of first base stations, where the second base station includes the foregoing baseband processor.

### BRIEF DESCRIPTION OF DRAWINGS

To describe the technical solutions in the embodiments of this disclosure or in the prior art more clearly, the following briefly introduces the accompanying drawings required for describing the embodiments or the prior art. Apparently, the accompanying drawings in the following description show some embodiments of this disclosure, and a person of ordinary skill in the art may still derive other drawings from these accompanying drawings without creative efforts.

FIG. 1 is a schematic diagram of simultaneously transmitting data for a plurality of user equipment by a distributed transmit unit;

FIG. 2 is a flowchart of a joint data transmission method according to one embodiment;

FIG. 3 is a schematic diagram of joint data transmission according to one embodiment;

FIG. 4 is a flowchart of another joint data transmission method according to one embodiment;

FIG. 5 is a schematic diagram of joint data transmission according to one embodiment;

FIG. 6 is a flowchart of another joint data transmission method according to one embodiment;

FIG. 7 is a schematic diagram of joint data transmission according to one embodiment;

FIG. 8 is a flowchart of another joint data transmission method according to one embodiment;

FIG. 9 is a schematic diagram of joint data transmission according to one embodiment;

FIG. 10 is a schematic structural diagram of a baseband processing unit according to one embodiment; and

FIG. 11 is a schematic structural diagram of a base station according to one embodiment.

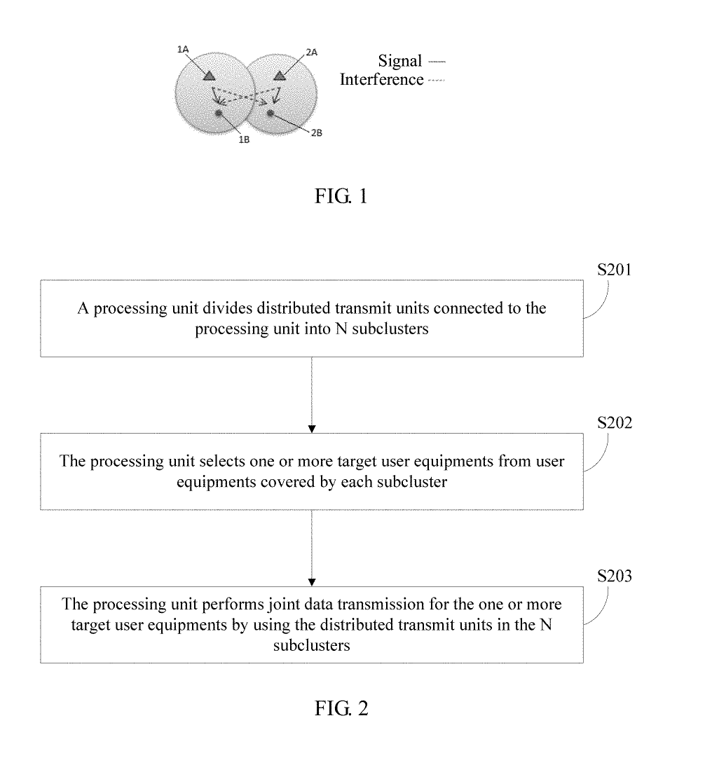

### DESCRIPTION OF EMBODIMENTS

The embodiments of this disclosure are applied to a scenario in which joint data transmission is performed between a plurality of distributed transmit units and a plurality of user equipment. The plurality of distributed transmit units may be RRUs connected to a same BBU, or may be a plurality of interconnected base stations, and the plurality of base stations are all connected to a BBU of one of the plurality of base stations.

The following describes the technical solutions in the embodiments of this disclosure with reference to the accompanying drawings in the embodiments of this disclosure.

FIG. 2 shows a joint data transmission method according to one embodiment. The method includes the following steps.

At S201, a processing unit (or processor) divides distributed transmit units connected to the processing unit into N subclusters, where N is an integer greater than or equal to one (1).

In one embodiment, the processing unit may be a BBU disposed individually, or may be a BBU disposed in a base station.

At S202, the processing unit selects one or more target user equipment from user equipment covered by each subcluster.

In one embodiment, the processing unit may perform S202 when performing Media Access Control (MAC) layer processing on to-be-transmitted data. That is, the processing unit may select, at a MAC layer, target user equipment from user equipment covered by each subcluster.

There is a plurality of policies for selecting the target user equipment. For example, selecting the target user equipment may include: selecting user equipment with a better channel status, selecting user equipment with a higher priority, selecting user equipment with better orthogonality between user equipment, scheduling user equipment in a rotation manner according to fairness, and some improved methods on such basis.

At S203, the processing unit performs joint data transmission for the one or more target user equipment by using the distributed transmit units in the N subclusters.

In one embodiment, the processing unit may perform S203 when performing physical layer processing on the to-be-transmitted data. That is, the processing unit may perform, at the physical layer, joint data transmission for the plurality of target user equipment by using a plurality of distributed transmit units.

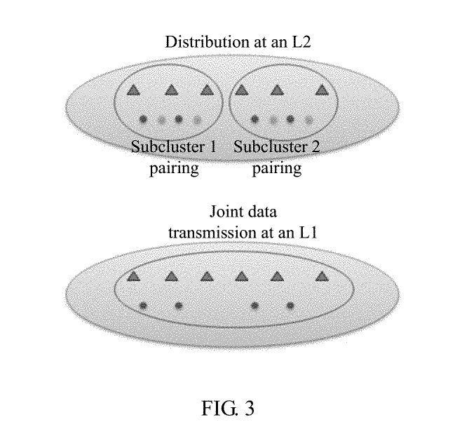

The foregoing processes are described by way of examples. Referring now to FIG. 3, L2 represents the MAC layer, L1 represents the physical layer, a triangle represents a distributed transmit unit, a dark-colored filled circle represents user equipment selected from a subcluster, that is, target user equipment, and a light-colored filled circle represents user equipment that is not selected in the subcluster.

In FIG. 3, the processing unit divides distributed transmit units into two subclusters. The processing unit selects, at an L2 layer, target user equipment from user equipment covered by the distributed transmit units of each subcluster, and performs, at an L1 layer, joint data transmission by using all distributed transmit units for target user equipment.

It can be learned that, in the method described in this embodiment, after the distributed transmit units are divided into clusters, target user equipment is selected from each subcluster, that is, consideration is performed on a user equipment group basis instead of a user equipment basis, thereby reducing complexity. In addition, regardless of which target user equipment are selected, all the distributed transmit units are used at the L1 layer for joint scheduling. This way, interference between subclusters can be avoided, thereby improving system performance.

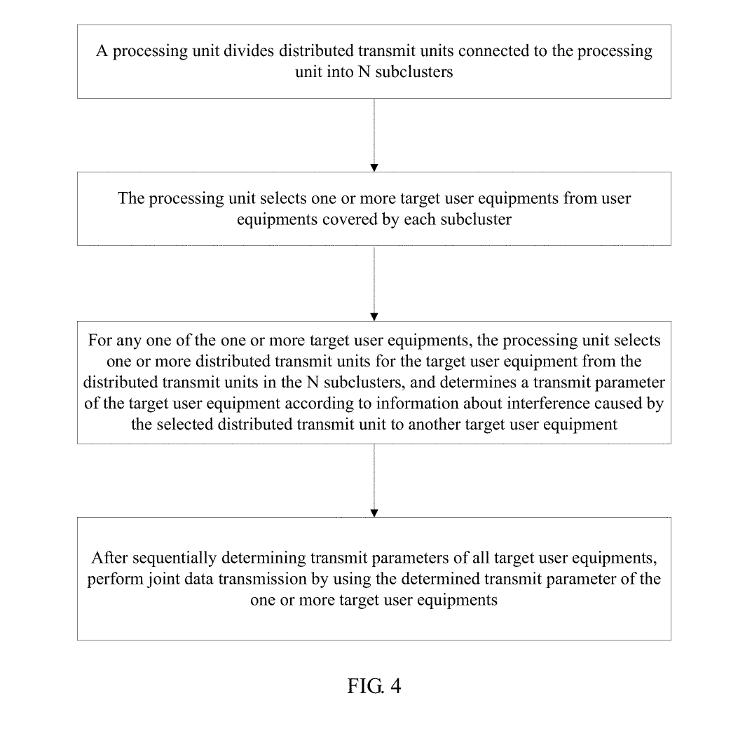

FIG. 4 is another joint data transmission method according to one embodiment. A difference with the method shown in FIG. 2 lies in that after selecting one or more target user equipment from each subcluster, for any one of the one or more target user equipment, the processing unit selects one or more distributed transmit units for the target user equipment from the distributed transmit units in the N subclusters, determines another target user equipment that receives interference from the selected distributed transmit unit, and determines a transmit parameter of the target user equipment according to information about the interference caused by the selected distributed transmit unit to the other target user equipment. After sequentially determining transmit parameters of all target user equipment, the processing unit performs joint data transmission by using the determined transmit parameter of the one or more target user equipment.

In one embodiment, there is a plurality of selection methods for selecting the distributed transmit unit for the target user equipment. For example:

1. The distributed transmit units are ranked according to strength of signals transmitted by the distributed transmit units to the user equipment, and one or more distributed transmit units having strongest transmit signal strength are selected.

2. All distributed transmit units whose ratio is greater than a preset value are selected according to a ratio of strength of a signal transmitted by each distributed transmit unit to the strength of a signal transmitted by the distributed transmit unit having strongest transmit signal strength.

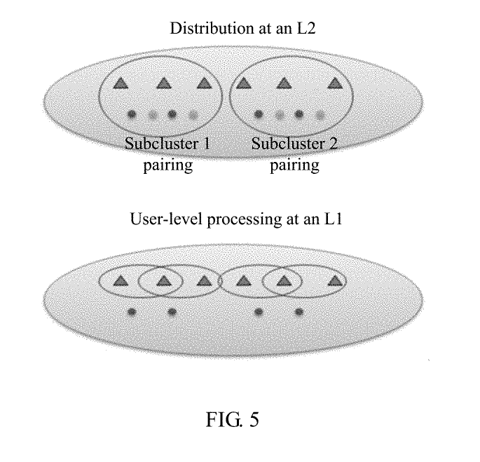

For example, as shown in FIG. 5, in an L1 layer processing stage, two leftmost distributed transmit units are selected for a first target user equipment (leftmost user equipment), and then it is determined that a second target user equipment adjacent to the first target user equipment receives interference from the two leftmost distributed transmit units.

Therefore, the processing unit performs joint data transmission by using the two leftmost distributed transmit units for the first target user equipment and the second target user equipment.

In the method described in this embodiment, clustering at the L2 layer can reduce computational complexity, parallel processing of a plurality of subclusters is implemented, and processing at the L1 layer is performed on a user equipment basis, so that computational complexity can be reduced and parallel processing is implemented while system performance is ensured.

Referring back to FIG. 4, when each distributed transmit unit has relatively many antennas, there is still a problem of relatively high complexity. For example, in a typical scenario, one user equipment (UE) can “see” three to five RRUs. That is, when each RRU has eight antennas, one UE can “see” 24 to 40 antennas. Therefore, when this quantity of antennas is used for joint data transmission, a computation amount is still relatively large.

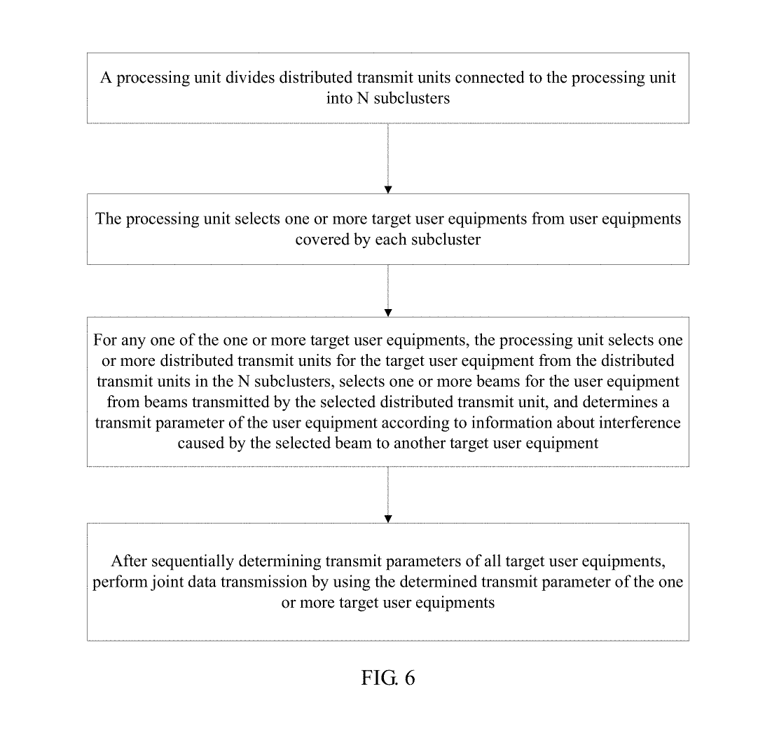

To further reduce computational complexity, the joint data transmission method shown in FIG. 6 is used. A difference between the method shown in FIG. 6 and that in FIG. 2 or FIG. 4 lies in that after selecting one or more target user equipment, for any one of the one or more target user equipment, the processing unit selects one or more distributed transmit units for the target user equipment from the distributed transmit units in the N subclusters, selects one or more beams for the user equipment from beams transmitted by the selected distributed transmit unit, determines another target user equipment that receives interference from the selected beam, and determines a transmit parameter of the user equipment according to information about the interference caused by the selected beam to the other target user equipment. After sequentially determining transmit parameters of all target user equipment, the processing unit performs joint data transmission by using the determined transmit parameter of the one or more target user equipment.

The beam is produced by a plurality of distributed transmit units in the N subclusters, and different beams to same user equipment have different radiation intensities.

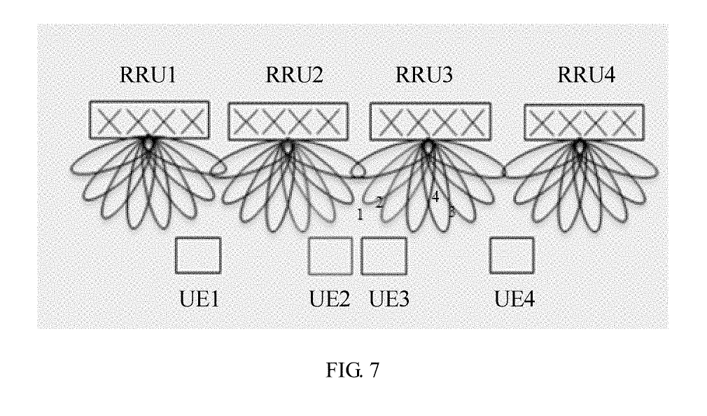

For example, as shown in FIG. 7, each RRU first produces a plurality of (analog/digital) beams pointing to different directions. Beams 1, 2, 3, and 4 are selected for UE2, and it is determined that the beams 1, 2, 3, and 4 produce interference to UE3. A transmission mode for the UE2 is determined according to the beams 1, 2, 3, and 4, the UE2, and the UE3. Finally, joint data transmission is performed for the UE2 by using the beams 1, 2, 3, and 4.

It can be learned that the method in this embodiment can further reduce joint data transmission complexity.

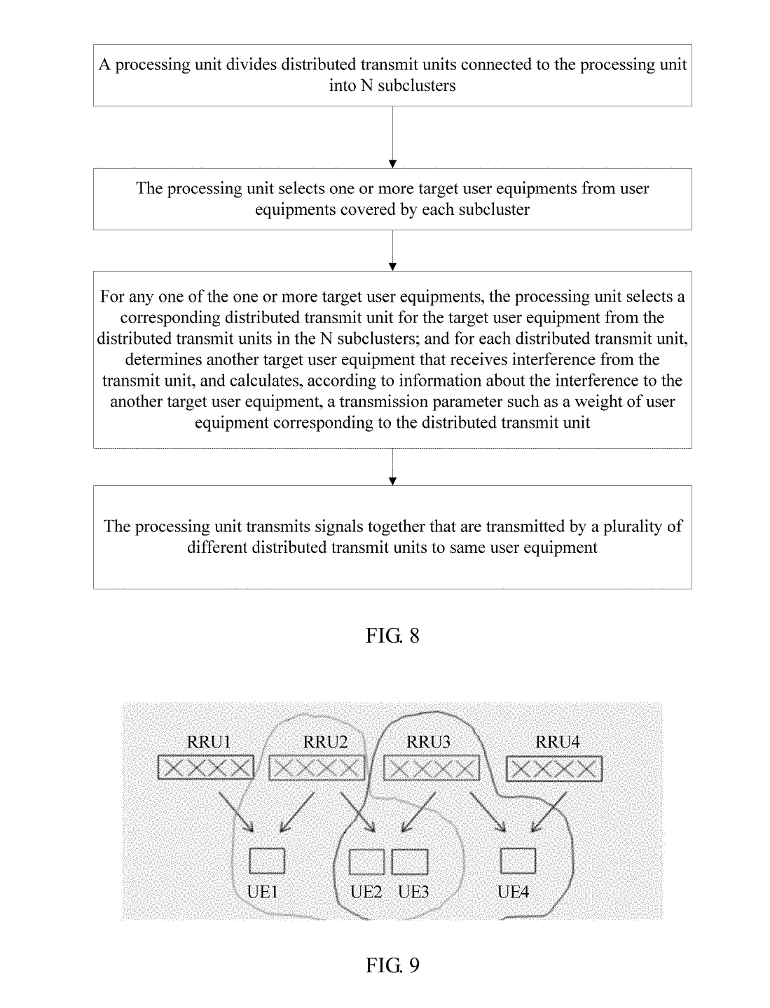

FIG. 8 is another joint data transmission method according to one embodiment. A difference with the foregoing embodiment lies in:

after selecting one or more target user equipment, for any one of the one or more target user equipment, the processing unit selects a corresponding distributed transmit unit for the target user equipment from the distributed transmit units in the N subclusters. For each distributed transmit unit, the processing unit determines another target user equipment that receives interference from the transmit unit, and calculates, according to information about the interference to the other target user equipment, a transmission parameter such as a weight of user equipment corresponding to the distributed transmit unit. The processing unit transmits signals together that are transmitted by a plurality of different distributed transmit units to same user equipment.

For example, as shown in FIG. 9, both RRU2 and RRU3 are selected for UE2 and UE3. The RRU2 calculates transmission parameters such as weights for performing joint data transmission for UE1, the UE2, and the UE3 by the RRU2. The RRU3 calculates transmission parameters such as weights for performing joint data transmission for the UE2, the UE3, and UE4 by the RRU3, and then the RRU2 and the RRU3 perform joint transmission for the UE2.

According to the method in this embodiment, complexity can be further reduced.

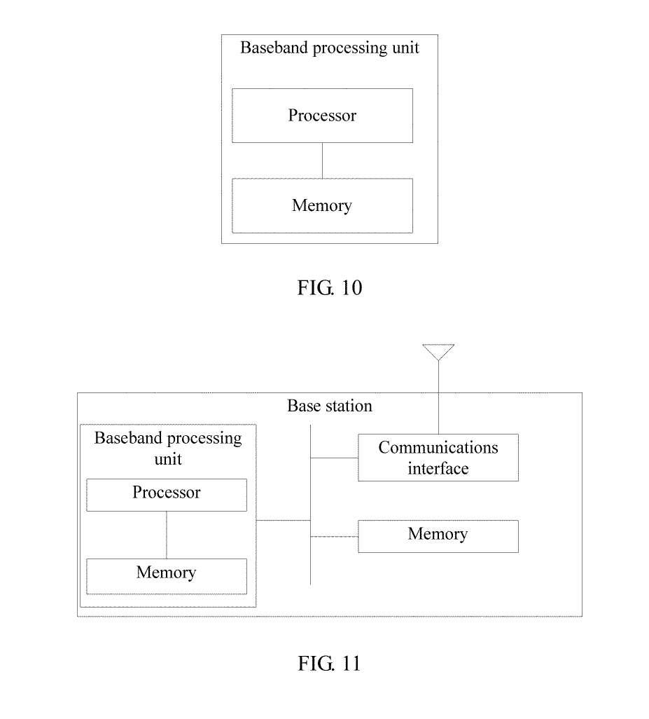

FIG. 10 is a baseband processing unit according to one embodiment. In one embodiment, the baseband processing unit includes a processor and a memory.

The memory may be a read-only memory (ROM), a static storage device, a dynamic storage device, or a random access memory (RAM). The memory is configured to store an application program and data generated in a process of running the application program by the processor.

The processor may be a general-purpose central processing unit (CPU), a microprocessor, an application-specific integrated circuit (ASIC), or one or more integrated circuits, and is configured to execute a related program.

The processor is configured to run the application program stored in the memory, so as to implement the processes shown in FIG. 2, FIG. 4, FIG. 6, and FIG. 8.

The baseband processing unit in this embodiment has relatively low computational complexity when performing joint data transmission by using a plurality of distributed transmit units.

FIG. 11 is a base station according to one embodiment. In one embodiment, the base station includes the baseband processing unit shown in FIG. 10. In addition, the base station may include a communications interface and a memory, and all components may communicate with each other via a bus.

An embodiment of this disclosure further discloses a distributed transmit system that includes a plurality of RRUs and a BBU connected to the plurality of RRUs, where the BBU is shown in FIG. 10.

An embodiment of this disclosure discloses another distributed transmit system that includes a plurality of first base stations and a second base station connected to the plurality of first base stations, where the second base station is shown in FIG. 11.

The foregoing distributed transmit systems have relatively low computational complexity when performing joint data transmission for a plurality of user equipment.

The embodiments in this disclosure are all described in a progressive manner, for same or similar parts in the embodiments, reference may be made to these embodiments, and each embodiment focuses on a difference from other embodiments.

The embodiments disclosed above are described to enable a person of ordinary skill in the art to implement or use this disclosure. Various modifications made to the embodiments will be obvious to a person of ordinary skill in the art, and the general principles defined herein may also be implemented in other embodiments without departing from the spirit or scope of this disclosure. Therefore, this disclosure is not intended to be limited to these embodiments illustrated herein, but shall be construed in the widest scope consistent with the principles and novel features disclosed herein.

What is claimed is:

1. A joint data transmission method, comprising:
dividing, by a processing unit, distributed transmit units connected to the processing unit into one or more subclusters;
selecting, by the processing unit, one or more target user equipment from user equipment covered by each subcluster; and
performing, by the processing unit, joint data transmission for the one or more target user equipment by using the distributed transmit units in the one or more subclusters.

2. The method according to claim 1, wherein performing joint data transmission for the one or more target user equipment comprises:
for any one of the one or more target user equipment, selecting, by the processing unit, one or more distributed transmit units for the target user equipment from the distributed transmit units in the one or more subclusters, determining another target user equipment that receives interference from the selected distributed transmit unit(s), and determining a transmit parameter of the target user equipment according to information about the interference caused by the selected distributed transmit unit(s) to the other target user equipment; and
performing, by the processing unit, joint data transmission by using a determined transmit parameter of the one or more target user equipment.

3. The method according to claim 2, wherein determining another target user equipment that receives interference from the selected distributed transmit unit(s) comprises:
selecting one or more beams for the target user equipment from beams transmitted by the selected distributed transmit unit(s), determining another target user equipment that receives interference from the selected beam(s); and
determining the transmit parameter of the target user equipment comprises:
determining a transmit parameter of the target user equipment according to information about the interference caused by the selected beam(s) to the other target user equipment, wherein each of the beams is produced by a plurality of distributed transmit units in the one or more subclusters, and different beams to different user equipment have different radiation intensities.

4. The method according to claim 1, wherein performing joint data transmission for the one or more target user equipment comprises:
for any one of the one or more target user equipment, selecting, by the processing unit, a corresponding distributed transmit unit for the target user equipment from the distributed transmit units in the one or more subclusters;
for each distributed transmit unit, determining, by the processing unit, another target user equipment that receives interference from the distributed transmit unit, and calculating, according to information about the interference to the other target user equipment, a transmission parameter of user equipment corresponding to the distributed transmit unit; and
transmitting, by the processing unit, signals together that are transmitted by a plurality of different distributed transmit units to corresponding user equipment.

5. A baseband processing unit, comprising:
a processor and a memory, wherein
the memory is configured to store an application program and data generated in a process of running the application program by the processor; and
the processor is configured to run the application program stored in the memory, to implement the following operations: dividing distributed transmit units connected to the processing unit into one or more subclusters; and selecting one or more target user equipment from user equipment covered by each subcluster, so that the distributed transmit units in the one or more subclusters perform joint data transmission for the one or more target user equipment.

6. The baseband processing unit according to claim 5, wherein the processor is further configured to:
for any one of the one or more target user equipment, select one or more distributed transmit units for the target user equipment from the distributed transmit units in the one or more subclusters, determine another target user equipment that receives interference from the selected distributed transmit unit, and determine a transmit parameter of the target user equipment according to information about the interference caused by the selected distributed transmit unit(s) to the other target user equipment; and perform joint data transmission by using a determined transmit parameter of the one or more target user equipment.

7. The baseband processing unit according to claim 5, wherein the processor is further configured to:
for any one of the one or more target user equipment, select one or more distributed transmit units for the target user equipment from the distributed transmit units in the one or more subclusters, select one or more beams for the target user equipment from beams transmitted by the selected distributed transmit unit(s), determine another target user equipment that receives interference from the selected beam(s), and determine a transmit parameter of the target user equipment according to information about the interference caused by the selected beam(s) to the other target user equipment; and perform joint data transmission by using a determined transmit parameter of the one or more target user equipment, wherein each of the beams is produced by a plurality of distributed transmit units in the one or more subclusters, and different beams to different user equipment have different radiation intensities.

8. The baseband processing unit according to claim 5, wherein the processor is further configured for the processing unit to:
for any one of the one or more target user equipment, select a corresponding distributed transmit unit for the target user equipment from the distributed transmit units in the one or more sub clusters;
for each distributed transmit unit, calculate, according to information about interference to the other target user equipment, a transmission parameter of user equipment corresponding to the distributed transmit unit; and
transmit signals together that are transmitted by a plurality of different distributed transmit units to corresponding user equipment.

9. A distributed transmit system, comprising:
a plurality of radio remote units (RRUs) and a baseband processing unit (BBU) connected to the plurality of RRUs, wherein the BBU comprising a processor and a memory, wherein
the memory is configured to store an application program and data generated in a process of running the application program by the processor; and
the processor is configured to run the application program stored in the memory, to implement the following operations: dividing distributed transmit units connected to the processing unit into one or more subclusters; and selecting one or more target user equipment from user equipment covered by each subcluster, so that the distributed transmit units in the one or more subclusters perform joint data transmission for the one or more target user equipment.

10. The distributed transmit system according to claim 9, wherein the processor is further configured to:
for any one of the one or more target user equipment, select one or more distributed transmit units for the target user equipment from the distributed transmit units in the one or more subclusters, determine another target user equipment that receives interference from the selected distributed transmit unit, and determine a transmit parameter of the target user equipment according to information about the interference caused by the selected distributed transmit unit to the other target user equipment; and perform joint data transmission by using a determined transmit parameter of the one or more target user equipment.

11. The distributed transmit system according to claim 9, wherein the processor is further configured to:
for any one of the one or more target user equipment, select one or more distributed transmit units for the target user equipment from the distributed transmit units in the one or more subclusters, select one or more beams for the target user equipment from beams transmitted by the selected distributed transmit unit(s), determine another target user equipment that receives interference from the selected beam(s), and determine a transmit parameter of the target user equipment according to information about the interference caused by the selected beam(s) to the other target user equipment; and perform joint data transmission by using a determined transmit parameter of the one or more target user equipment, wherein each of the beams is produced by a plurality of distributed transmit units in the one or more subclusters, and different beams to different user equipment have different radiation intensities.

12. The distributed transmit system according to claim 9, wherein the processor is further configured for the processing unit to:
for any one of the one or more target user equipment, select a corresponding distributed transmit unit for the target user equipment from the distributed transmit units in the one or more sub clusters;
for each distributed transmit unit, calculate, according to information about interference to the other target user equipment, a transmission parameter of user equipment corresponding to the distributed transmit unit; and
transmit signals together that are transmitted by a plurality of different distributed transmit units to corresponding user equipment.
